(19) United States
(12) Patent Application Publication
(10) Pub. No.: US 2008/0117139 A1
(43) Pub. Date: May 22, 2008

(54) Plasma display panel

(76) Inventors: Hyun Soh, Suwon-si (KR); Se-Jong Kim, Suwon-si (KR); Yun-Hee Kim, Suwon-si (KR); Hyun Kim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/825,160

(22) Filed: Jul. 3, 2007

(30) Foreign Application Priority Data
Nov. 20, 2006 (KR) 10-2006-0114707

(51) Int. Cl. G09G 3/28

(52) U.S. Cl. 345/66

(57) ABSTRACT

Provided is a plasma display panel (PDP) including: a first substrate and a second substrate facing each other; barrier ribs that are arranged between the first and second substrates and that partition a plurality of discharge cells; sustain electrode pairs that are spaced apart from each other on the first substrate, each sustain electrode pair including an X electrode and a Y electrode; and a first dielectric layer that covers the sustain electrode pairs and includes grooves such that at least two grooves correspond to each of the discharge cells and exhaust passages that linearly connect the grooves of neighboring discharge cells, wherein a distance between the X electrodes and the Y electrodes is larger than a height of the barrier ribs.

### CROSS-REFERENCE TO RELATED PATENT APPLICATION

This application claims the benefit of Korean Patent Application No. 10-2006-0114707, filed on Nov. 20, 2006 in the Korean Intellectual Property Office, the disclosure of which is incorporated herein in its entirety by reference.

### BACKGROUND OF THE INVENTION

1. Field of the Invention

The present embodiments relate to a plasma display panel, and more particularly, to a plasma display panel with improved luminous efficiency.

2. Description of the Related Art

Plasma display panels (PDP), which have been highlighted recently as replacements for conventional cathode ray tube displays, are flat display panels in which a discharge gas is sealed between two panels including a plurality of electrodes in which a discharge voltage is applied thereto to excite phosphors formed in a predetermined pattern by ultraviolet rays generated by the voltage to obtain desired images.

Regarding PDP design, it is important to design PDPs to be driven at a predetermined discharge voltage or lower while having high luminous efficiency. The present embodiments detail a PDP with a design which achieves a low discharge voltage but maintains an advantageous high luminous efficiency.

### SUMMARY OF THE INVENTION

The present embodiments provide a plasma display panel (PDP) which is driven at a predetermined discharge voltage or lower and has improved luminous efficiency.

According to an aspect of the present embodiments, there is provided a plasma display panel (PDP) comprising: a first substrate and a second substrate facing each other; barrier ribs that are arranged between the first and second substrates and that partition a plurality of discharge cells; sustain electrode pairs that are spaced apart from each other on the first substrate, each sustain electrode pair including an X electrode and a Y electrode; and a first dielectric layer that covers the sustain electrode pairs and includes grooves such that at least two grooves correspond to each of the discharge cells and exhaust passages that linearly connect the grooves of neighboring discharge cells, wherein a distance between the X electrodes and the Y electrodes is larger than a height of the barrier ribs.

The exhaust passages may be arranged parallel to the sustain electrode pairs.

The width of the exhaust passages may be the same as the width of the grooves or smaller.

Two grooves may be formed in each of the discharge cells, and the two grooves may be arranged to respectively correspond to the X electrode and the Y electrode of each corresponding discharge cell.

The PDP of claim 4, wherein the X electrodes and the Y electrodes include bus electrodes and transparent electrodes that are formed on the bus electrodes, and at least a portion of the grooves are arranged to correspond to the transparent electrodes.

The transparent electrodes protrude from the bus electrodes towards the discharge cells.

The transparent electrodes comprise indium tin oxide (ITO).

The first dielectric layer comprises Bi₂O₃.

The PDP may further comprise: address electrodes crossing the sustain electrode pairs; a second dielectric layer covering the address electrodes; and phosphor layers arranged in the discharge cells.

Sides of the grooves are inclined with respect to the first substrate.

The depth of the grooves may be the same or smaller than the thickness of the first dielectric layer.

The depth of the exhaust passages may be the same or smaller than the depth of the grooves.

The PDP may further comprise a protection layer covering the first dielectric layer, wherein the protection layer is formed on sides of the grooves.

### BRIEF DESCRIPTION OF THE DRAWINGS

The above and other features and advantages of the present embodiments will become more apparent by describing in detail exemplary embodiments thereof with reference to the attached drawings in which:

FIG. 1 is a separated perspective view illustrating a conventional three-electrode type surface discharge AC type plasma display panel (PDP);

FIG. 2 is a separated perspective view illustrating a PDP according to an embodiment;

FIG. 3 is a cross-sectional view of FIG. 2 taken along line III-III;

FIG. 4 is a cross-sectional view of FIG. 2 taken along line IV-IV;

FIGS. 5A and 5B are graphs of turn-on voltage against luminous efficiency for PDPs according to the conventional PDP each having a different value for the distance between the X and Y electrodes thereof; and

FIG. 6 illustrates an arrangement of discharge cells, electrodes, and first and second grooves illustrated in the PDP of FIG. 2.

### DETAILED DESCRIPTION OF THE INVENTION

The present embodiments will now be described more fully with reference to the accompanying drawings, in which exemplary embodiments are shown.

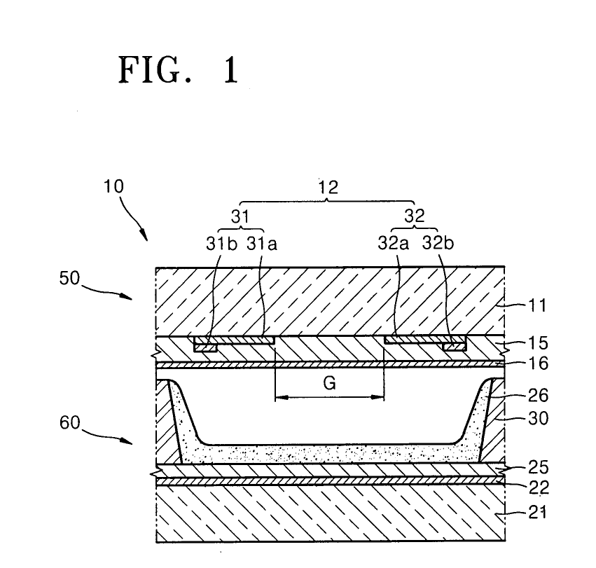

FIG. 1 illustrates a typical three-electrode type surface discharge AC type plasma display panel (PDP) 10. Referring to FIG. 1, the PDP 10 includes a front panel 50 and a rear panel 60 that is coupled parallel to the front panel 50. Sustain electrode pairs 12 each comprising an X electrode 31 and a Y electrode 32 are disposed on a first substrate 11 of the front panel 50, and address electrodes 22 are disposed on a second substrate 21 of the rear panel 60 facing the first substrate 11 to cross the X electrodes 31 and the Y electrodes 32. The Y electrodes 32 and the X electrodes 31 each include transparent electrodes 32a and 31a and bus electrodes 32b and 31b. Thus, one unit discharge cell is defined by the point at which one sustain electrode pair 12 comprising one Y electrode 31 and one X electrode 32 crosses one of the address electrodes 22. Thus, a first dielectric layer 15 and a second dielectric layer 25 are formed on each of the first substrate 11 and the second substrate 21 to cover each electrode. A protection layer 16 formed of, for example, MgO is formed on the first dielectric layer 15, and barrier ribs 30 maintaining discharge distances between the front panel 50 and the rear panel 60 and preventing cross-talk between the discharge cells are formed on a front surface of the second dielectric layer 25. Phosphor layers 26 are coated on both sidewalls of the barrier ribs 30 and a front surface of the second dielectric layer 25 where barrier ribs 30 are not formed.

In the PDP 10, as the distance G between the X electrode and the Y electrode of a sustain electrode pair 12 is increased, the distance between a corresponding address electrode 22 and the X electrode 31 and the Y electrode 32 becomes similar to the distance G. Thus, as long as discharge is initiated and maintained, the discharge between the three electrodes 31, 32, and 22 becomes diffusive, and thus discharge is extended to not only occur near to the front panel 50 but also to occur near to the rear panel 60, thereby increasing luminous efficiency. Accordingly, though the distance G between the X electrode and the Y electrode 32 should be increased to increase luminous efficiency, the turn-on voltage should also be increased as the distance G is increased.

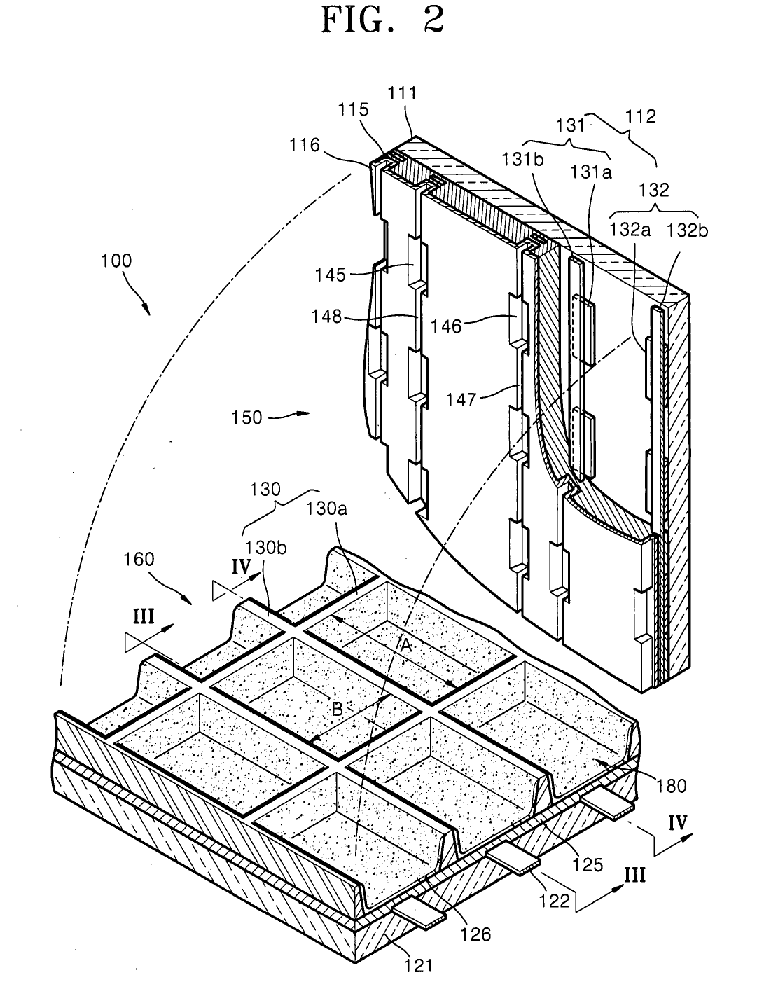

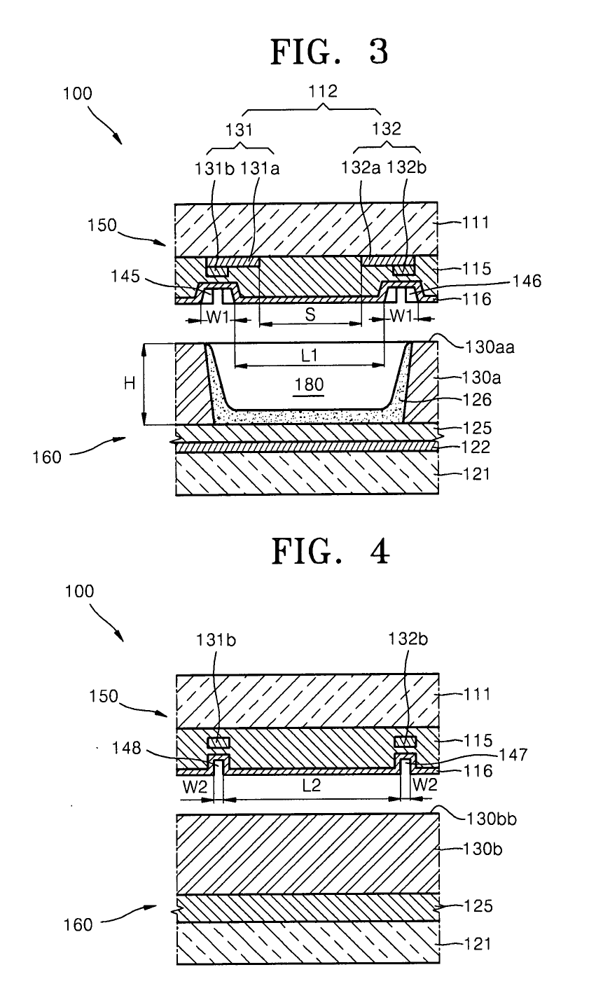

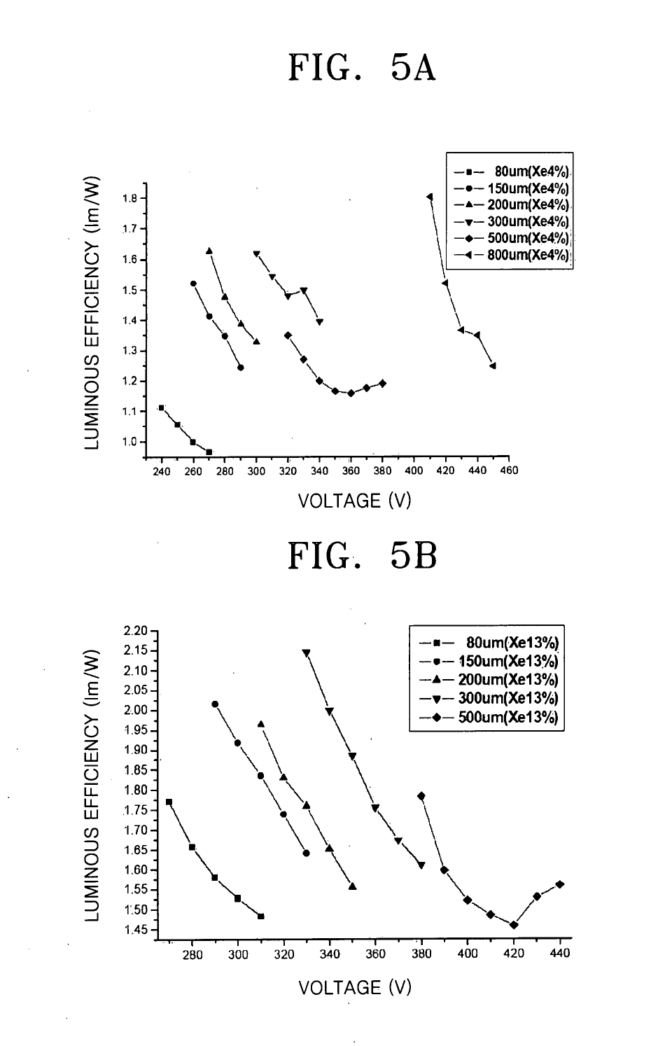

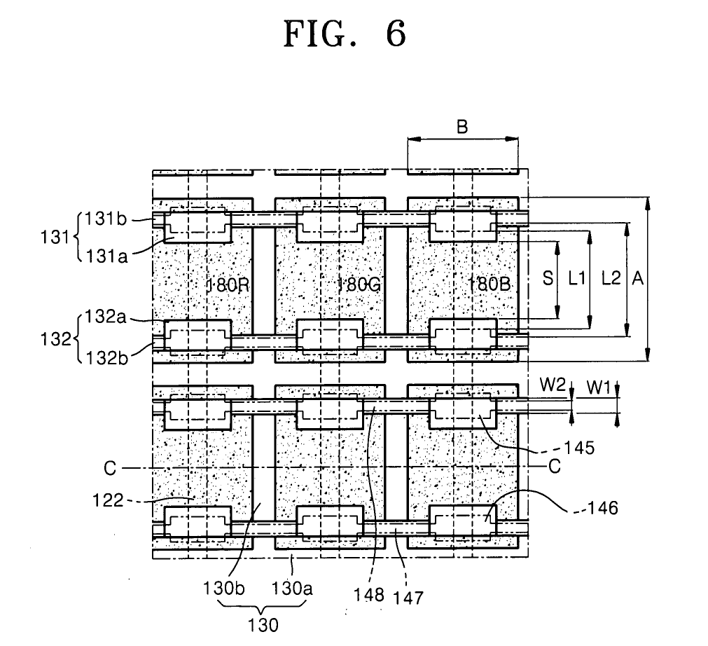

FIG. 2 is a separated perspective view illustrating a PDP 100 according to some embodiments. FIG. 3 is a cross-sectional view of FIG. 2 taken along line III-III. FIG. 4 is a cross-sectional view of FIG. 2 taken along line IV-IV. FIGS. 5A and 5B are graphs of turn-on voltage against luminous efficiency for PDPs according to the present embodiments each having a different value for the distance between the X and Y electrodes thereof. FIG. 6 illustrates an arrangement of discharge cells, electrodes, and first and second grooves of the PDP of FIG. 2.

As illustrated in FIG. 2, the PDP 100 includes a front panel 150 and a rear panel 160 that is coupled parallel to the front panel 150. The front panel 150 includes a first substrate 111, a first dielectric layer 115, sustain electrode pairs 112, and a protection layer 116, and the rear panel 160 includes a second substrate 121, address electrodes 122, a second dielectric layer 125, barrier ribs 130, and phosphor layers 126.

The first substrate 111 and the second substrate 121 are separated a predetermined distance apart from each other, and define a discharge space in which discharge is generated. The first and second substrates 121 may be formed of a material having good visible light transmittance, such as, for example, glass. To increase bright room contrast, the first substrate 111 and/or the second substrate 121 may be colored.

The barrier ribs 130 are formed between the first and second substrates 111 and 121; specifically, the barrier ribs 130 are formed on the second dielectric layer 125. The barrier ribs 130 define the discharge space into a plurality of red, green, and blue discharge cells 180 and prevent optical/electric cross-talk between the discharge cells 180.

Referring to FIG. 2, the barrier ribs 130 are illustrated defining discharge cells 180 in a grid arrangement having a repeating unit with a rectangular cross-section. The barrier ribs 130 include first barrier ribs portions 130a that are arranged parallel to the sustain electrode pairs 112 and second barrier ribs portions 130b connecting the first barrier ribs 130a. Accordingly, as each discharge cell 180 is surrounded by one pair of first barrier ribs portions 130a and by one pair of the second barrier ribs portions 130b formed perpendicular to the first barrier ribs 130a, the repeating unit of the barrier ribs 130 has a closed form. However, the present embodiments are not limited thereto, that is, the repeating unit of the barrier ribs 130 may be formed having a closed form such that each discharge cell 180 has a cross-section that is based on a polygon such as a triangle, a pentagon, a circle, an oval, or an open form such as stripe. Also, the barrier ribs 130 may define the discharge cells 180 to have a waffle or delta arrangement.

Each discharge cell 180 has a short side B parallel to the sustain electrode pairs 112 and a long side A perpendicular to the sustain electrode pairs 112.

The sustain electrode pairs 112 are arranged on the first substrate 111 facing the second substrate 121. Each sustain electrode pair 112 denotes one pair of sustain electrodes 131 and 132 that are formed on an inner surface of the first substrate 111 such that the sustain electrode pairs 112 are formed on the first substrate 111, each sustain electrode pair 112 being separated a predetermined distance apart from an adjacent sustain electrode pair 112.

One of each sustain electrode pair 112 is an X electrode 131 which functions as a common electrode and the other is a Y electrode 132 which functions as a scanning electrode. According to the current embodiment, the sustain electrode pairs 112 are directly arranged on the first substrate 111 but the arrangement of each sustain electrode pair 112 is not limited thereto. For example, the X electrode 131 and the Y electrode 132 of each sustain electrode pair 112 may be separated a predetermined distance apart in a direction from the first substrate 111 to the second substrate 121.

A first dielectric layer 115 is formed on the first substrate 111 to cover the sustain electrode pairs 112. The first dielectric layer 115 prevents neighboring X electrodes 131 and Y electrodes 132 from being electrically connected to each other and, at the same time, prevents charged particles or electrons from directly colliding with the X electrodes and Y electrodes 132, thus preventing damage to the X electrodes 131 and the Y electrodes 132. Also, the first dielectric layer 115 induces charges.

Referring to FIGS. 2 and 3, first grooves 145 and second grooves 146 are formed on the first dielectric layer 115. The first and second grooves 145 and 146 are formed in the first dielectric layer to a predetermined depth, and the depth of the first and second grooves 145 and 146 are determined in consideration of the possibility of damage of the first dielectric layer 115, the arrangement of wall charges, and the discharge voltage. Thus the depth of the first grooves and the second grooves may be the same as the thickness of the first dielectric layer 115 or less.

Referring to FIGS. 2 and 4, a first exhaust passage 148 and a second exhaust passage 147 which linearly connect the grooves of neighboring discharge cells are formed in the first dielectric layer 115. That is, the first exhaust passage 148 linearly connects the first grooves 145 of neighboring discharge cells, and the second exhaust passage 147 linearly connects the second grooves 146 of neighboring discharge cells.

As illustrated in FIGS. 2 and 4, the first and second exhaust passages 148 and 147 extend in a direction parallel to the sustain electrode pairs 112 and linearly connect grooves of neighboring discharge cells. Here, the first and second exhaust discharge passages 148 and 147 are formed as grooves having a side open toward the discharge cells, but the form is not limited thereto and may be of a closed duct type.

FIG. 3 illustrates a cross-section of grooves and FIG. 4 illustrates a cross-section of discharge passages. Referring to FIGS. 3 and 4, sides of the first and second grooves 145 and 146 are inclined with respect to the first substrate 111 but are not limited thereto and may take various forms. A distance between the transparent electrodes 131a and 132a is denoted by S, and a distance between nearest edges of the first groove 145 and the second groove 146 is denoted by L1, and a distance between nearest edges of the first discharge passage 148 and the second discharge passage 147 is denoted by L2.

The distance L1 may be longer than the distance S. Also, a width W1 of the first groove 145 and the second groove 146 corresponding to a discharge cell 180 is the same as or greater than a width W2 of the first and second exhaust passages 148 and 147 that linearly connect the first and second grooves 145 and 146. The width of the exhaust passages is the same as or smaller than the width of the grooves. The exhaust passages will be described later in detail.

The depth of the first and second exhaust passages 148 and 147 may be the same as or smaller than the depth of the first and second grooves 145 and 146.

FIGS. 5A and 5B are graphs of turn-on voltage against luminous efficiency for PDPs according to the conventional PDP, each having a different value for the distance between the X and Y electrodes thereof. FIG. 5A is a graph showing measurements taken using a discharge gas comprising 4% Xe, and FIG. 5B is a graph showing measurements taken using a discharge gas comprising 13% Xe. FIG. 5A shows measurements taken when the distance G is 80 μm, 150 μm, 200 μm, 300 μm, 500 μm, and 800 μm. FIG. 5B shows measurements taken when the distance G is 80 μm, 150 μm, 200 μm, 300 μm, and 500 μm.

Referring to FIGS. 5A and 5B, as the distance G between the X electrode 31 and the Y electrode 32 of a typical PDP in FIG. 1 is increased, the luminous efficiency is increased. As the distance G between the X electrode 31 and the Y electrode 32 is increased, the distance from the address electrode 22 to the X electrode 31 and the Y electrode 32 becomes similar to the distance G between the X electrode 31 and the Y electrode 32. Accordingly, as discharge is initiated and maintained, the discharge between the three electrodes 31, 32, and 22 becomes diffusive and is extended to occur not only near the front panel 50 but also near the rear panel 60, thereby increasing luminous efficiency. Accordingly, it is desirable to increase the distance G between the X electrode 31 and the Y electrode 32.

However, as the distance G between the X electrode 31 and the Y electrode 32 is increased, the turn-on voltage also increases. That is, as the distance between the X electrode 31 and the Y electrode 32 is increased, the charge accumulation amount between the X electrode 31 and the Y electrode 32 is decreased at a predetermined voltage, thereby reducing capacitance. Accordingly, a high sustain voltage is needed to activate discharge between the X electrode 31 and the Y electrode 32.

As described above, in order to increase the luminous efficiency by increasing the distance G, a distance S between the X electrode 131 and the Y electrode 132 (see FIG. 3) is arranged to be larger than a height H of the barrier ribs 130. Here, in order to prevent the turn-on voltage from increasing over a predetermined voltage, for example, about 300 V, the distance S may be from about 110 to about 260 μm, referring to FIGS. 5A and 5B. The distance S between the X electrode 131 and the Y electrode 32 may be a about one fourth of or about one half of the long side A of the discharge cells 180.

Referring to FIGS. 3, 4 and 6, each of the X electrodes 131 and the Y electrodes 132 includes transparent electrodes 131a and 132a and bus electrodes 131b and 132b. The transparent electrodes 131a and 132a are formed of a material, for example, indium tin oxide (ITO), which is a conductor that can generate discharge and does not interfere with light that is emitted from the phosphor layer 126 and propagates toward the first substrate 111. However, the transparent electrodes 131a and 132a formed of ITO have a large voltage drop in a length direction and thus consume a lot of electricity and have a slow response speed. In order to improve this, electrodes 131b and 132b formed of metal and having a small width are disposed on the transparent electrodes 131a and 132a. The bus electrodes 131b and 132b may be formed as a single layer using metals such as, for example, Ag, Al, or Cu, but may also be formed as a multi-layer structure. The transparent electrodes and bus the electrodes can be formed using a photographic etching method, a photolithography method, or the like.

Hereinafter, the form and arrangement of the X electrodes 131 and the Y electrodes 132 will be described in detail with reference to FIG. 6. The bus electrodes 131b and 132b are separated a predetermined distance apart from each other, are parallel to each other in the discharge cells 180 and extend across the discharge cells 180 in one direction. The bus electrodes 131b and 132b are arranged to be separated a predetermined distance from the first barriers ribs 130a and a predetermined distance from the center of the discharge cells 180.

As described above, the transparent electrodes 131a and 132a are electrically connected to the bus electrodes 131b and 132b, respectively, and the transparent electrodes 131a and 132a are disposed discontinuously in each discharge cell 180 in a rectangular form. One end of the transparent electrodes 131a and 132a is connected to the bus electrodes 131b and 132b, respectively, and the other end protrudes toward the center of the discharge cell 180. The form of the transparent electrodes 131a and 132a is not limited to be rectangular but may be of various shapes to increase the surface area of the transparent electrodes.

Also, since the thickness of the first dielectric layer 115 is reduced due to the first grooves 145 and the second grooves 146 which are formed to correspond to each discharge cell in the first dielectric layer 115, the transmittance of visible light in a forward direction is increased. Also, around a virtual symmetric surface C—C of the sustain electrode pairs 112, the first grooves 145 and the second grooves 146 may be formed to correspond symmetrically.

The first grooves 145 and the second grooves 146 are linearly connected to first and second grooves of other discharge cells 180 by the first and second exhaust passages 148 and 147. The first and second exhaust passages 148 and 147 extend along the direction of the X electrodes 131 and the Y electrodes 132 which form sustain electrode pairs 112. The exhaust passages linearly connect grooves of neighboring discharge cells over the barrier ribs.

The first grooves 145 are formed to correspond to the X electrodes 131 and the second grooves 146 are formed to correspond to the Y electrodes 132. However, the location of the first grooves 145 may vary. That is, the first grooves 145 may be formed to correspond only to the first transparent electrodes 131a, or only to a portion of the bus electrodes 131b, or to a portion not corresponding to the X electrode 131. The location of the second grooves 146 may also vary.

The first and second grooves 145 and 146 can be formed in various manners, for example, by coating a dielectric substance on the first substrate 111 and etching the first substrate 111. This method reduces costs and is simple. However, a dielectric substance that can be used in PDPs is a PbO—B₂O₃—SiO₂ (lead borosilicate) composition including Pb based materials. The dielectric substance includes a predetermined amount or higher of SiO₂ to control the dielectric rate, the thermal expansion coefficient, and the reaction with bus electrodes. However, since the dielectric substance includes Pb, it is harmful to humans. In order to solve this problem, the first dielectric layer 115 is formed of a Bi based material and the Bi based material may include Bi₂O₃. Accordingly, the first dielectric layer 115 may be formed to be a Bi₂O₃—B₂O₃—ZnO composition.

The dielectric pattern, which is etched at the same time with the grooves, minimizes cross-talk since the etching speed is different depending on the size of the dielectric pattern per a time unit.

The first dielectric layer 115 is covered by the protection layer 116. The protection layer 116 prevents charged particles and electrons from colliding with the first dielectric layer 115 during discharge in order to prevent damage to the first dielectric layer 115. Also, the protection layer 116 emits secondary electrons during discharge to facilitate plasma discharge. The protection layer 116 is formed of a material that has a high coefficient of secondary electron emission and high transmittance of visible light. The protection layer 116 is formed as a thin layer using a sputtering method or electron beam deposition method after the first dielectric layer 115 is formed.

Since the protection layer 116 is formed after grooves and exhaust passages are formed in the first dielectric layer 115, the protection layer 116 may be formed on sides of the grooves and the exhaust passages.

Address electrodes 122 are disposed on the second substrate 121 facing the first substrate 111. The address electrodes 122 extend across the discharge cells 180 to cross the X electrodes 131 and the Y electrodes 132.

The address electrodes 122 generate address discharge for generating sustain discharge more easily between the X electrodes 131 and the Y electrodes 132, and the address electrodes 122 reduce the voltage required for generating sustain discharge. The address discharge refers to a discharge that is generated between the Y electrode 132 and the address electrode 122.

A second dielectric layer 125 is formed on the second substrate 121 to cover the address electrode 122. The second dielectric layer 125 is formed of a dielectric substance that can prevent charged particles or electrons from colliding with the address electrode 122 during discharge so as to reduce damage the address electrodes and that can induce charges, for example, of a Bi₂O₃—B₂O₃—ZnO composition.

Red, green, and blue light emitting phosphor layers 126 are arranged on sidewalls of the barrier ribs 130 formed on the second dielectric layer 125 and on a front surface of the second dielectric layer 125. The phosphor layers 126 generate visible light when exposed to ultraviolet rays. The phosphor layer formed in the red light emitting discharge cells includes a phosphor such as Y(V,P)O4:Eu. The phosphor layer formed in the green light emitting discharge cell includes a phosphor such as Zn2SiO4:Mn, or YBO3:Tb. The phosphor layer formed in the blue light emitting discharge cell includes a phosphor such as BAM:Eu.

Also, a discharge gas in which neon (Ne), xenon (Xe), or the like are mixed is filled in the discharge cells 180, and as the discharge gas is filled as described above, the first and second substrates 111 and 121 are sealed and coupled by a sealing member such as frit glass that is formed at edges of the first and second substrates 111 and 121.

Hereinafter, the operation of the PDP 100 manufactured as described above will be described.

Plasma discharge that is generated in the PDP is divided into address discharge and sustain discharge. Address discharge is generated by applying an address discharge voltage between the address electrode 122 and the Y electrode 132, and the discharge cells 180, in which sustain discharge is to be generated, are selected as the result of the address discharge.

Then a sustain voltage is applied between the X electrode 131 and the Y electrode 132 of the selected discharge cells 180. Here, an electric field is concentrated on the first and second grooves 145 and 146 formed in the first dielectric layer 115, thereby reducing the discharge voltage. The reason for this is that the discharge path between the X electrode 131 and the Y electrode 132 is reduced, and a strong electric field is generated in the discharge path, concentrating the electric field, and thus, the density of charges and charged particles is great and a high excitation state is realized.

As the energy potential of the discharge gas excited during sustain discharge decreases, ultraviolet rays are emitted. The ultraviolet rays excite the phosphor layers 126 coated in the discharge cells 180, and as the energy potential of the excited phosphor layers 126 decreases, visible light is emitted, and the visible light is transmitted through the first dielectric layer 115 and the first substrate 111 and emitted to form an image a user can recognize.

Hereinafter, the increase in the luminous efficiency due to the first and second grooves 145 and 146 will be described.

In a conventional PDP, discharge started between an X electrode 31 and a Y electrode 32 is extended as time passes to the outside of the X electrode 31 and the Y electrode 32. However, since the electron density outside the X electrode 31 and the Y electrode 32 is very low, it is difficult to generate active plasma discharge. Accordingly, a long discharge path having high efficiency is not practical. In particular, as the discharge path becomes short, it is difficult to reach the excitation state of Xe in the discharge gas, and thus it is difficult to increase luminous efficiency of the conventional PDP.

However, according to the present embodiments, the electron density in the first and second grooves 145 and 146 is increased significantly, and thus the electric field in the first dielectric layer 115, in which the first and second grooves 145 and 146 are formed, is concentrated. Also, since discharge over a long discharge path having high efficiency is actively generated, the luminous efficiency is increased significantly.

In addition, since the potential difference between the X electrodes 131 and the Y electrodes 132 participating in diffusion is lower than the potential difference between the X electrodes 31 and the Y electrode 32 of a conventional PDP, it is easy to diffuse the discharge to both upper and lower parts of the discharge cells 180 due to the first and second grooves 145 and 146. Thus the discharge path can be maximized at a low sustain voltage, thereby increasing luminous efficiency.

Also, as the first and second grooves 145 and 146 of neighboring discharge cells are linearly connected by the first and second exhaust passages 148 and 147, the exhaust and gas injection characteristics can be improved compared to when the first and second grooves are not discontinuously connected.

The PDP according to the present embodiments has reduced turn-on voltage, significantly increased discharge efficiency, and improved exhaust and gas injection performance, which thereby improve the discharge stability of the PDP.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel (PDP) comprising:
a first substrate and a second substrate facing each other;
barrier ribs arranged between the first and second substrates that partition a plurality of discharge cells;
sustain electrode pairs that are spaced apart from each other on the first substrate, wherein each sustain electrode pair includes an X electrode and a Y electrode; and
a first dielectric layer that covers the sustain electrode pairs and includes grooves such that at least two grooves correspond to each of the discharge cells; and
exhaust passages that linearly connect the grooves of neighboring discharge cells,
wherein the distance between the X electrodes and the Y electrodes is larger than the height of the barrier ribs.

2. The PDP of claim 1, wherein the exhaust passages are arranged parallel to the sustain electrode pairs.

3. The PDP of claim 1, wherein the width of the exhaust passages is the same as the width of the grooves or smaller.

4. The PDP of claim 1, wherein two grooves are formed in each of the discharge cells, and wherein the two grooves are arranged to respectively correspond to the X electrode and the Y electrode of each corresponding discharge cell.

5. The PDP of claim 4, wherein the X electrodes and the Y electrodes include bus electrodes and transparent electrodes that are formed on the bus electrodes and at least a portion of the grooves are arranged to correspond to the transparent electrodes.

6. The PDP of claim 5, wherein the transparent electrodes protrude from the bus electrodes towards the discharge cells.

7. The PDP of claim 6, wherein the transparent electrodes comprise indium tin oxide (ITO).

8. The PDP of claim 1, wherein the first dielectric layer comprises Bi₂O₃.

9. The PDP of claim 1, further comprising:
address electrodes crossing the sustain electrode pairs;
a second dielectric layer covering the address electrodes; and
phosphor layers arranged in the discharge cells.

10. The PDP of claim 1, wherein sides of the grooves are inclined with respect to the first substrate.

11. The PDP of claim 1, wherein the depth of the grooves is the same or smaller than the thickness of the first dielectric layer.

12. The PDP of claim 11, wherein the depth of the exhaust passages is the same or smaller than the depth of the grooves.

13. The PDP of claim 1, further comprising a protection layer covering the first dielectric layer, wherein the protection layer is formed on sides of the grooves.

14. The PDP of claim 13, wherein the protection layer comprises MgO.

15. The PDP of claim 1, wherein the discharge cells have a cross-section that is based on one selected from the group consisting of a square, a rectangle, a triangle, a pentagon, a circle and an oval.

16. The PDP of claim 1, wherein the discharge cells have an open form.
